(19) United States
(12) Patent Application Publication
(10) Pub. No.: US 2026/0285766 A1
(43) Pub. Date: Sep. 24, 2026

(54) CERAMIC SPEAKER AND MANUFACTURING METHOD THEREFOR

(71) Applicant: AMOSENSE CO.,LTD, Cheonan-si, Chungcheongnam-do (KR)

(72) Inventors: Jae-Yong SONG, Cheonan-si, Chungcheongnam-do (KR); Jong-Kwan CHOI, Cheonan-si, Chungcheongnam-do (KR); Jeong-Sang YU, Cheonan-si, Chungcheongnam-do (KR); Chang-Woo OH, Cheonan-si, Chungcheongnam-do (KR)

(73) Assignee: AMOSENSE CO.,LTD, Cheonan-si, Chungcheongnam-do (KR)

(21) Appl. No.: 19/474,550

(22) PCT Filed: Apr. 9, 2024
(86) PCT No.: PCT/KR2024/004733

§ 371 Date: Dec. 9, 2025

(30) Foreign Application Priority Data
Apr. 12, 2023 (KR) 10-2023-0048101

(51) Int. Cl. C04B 35/491; C04B 35/626; C04B 35/63; C04B 35/638; C04B 35/645; H04R 17/00; H04R 31/00

(52) U.S. Cl. CPC C04B 35/491; C04B 35/62675; C04B 35/6303; C04B 35/638; C04B 35/645; H04R 17/00; H04R 31/00; C04B 2235/3249; C04B 2235/3294; C04B 2235/3298; C04B 2235/442; C04B 2235/656; C04B 2235/95

(57) ABSTRACT

A ceramic speaker is implemented such that height deviation thereof in the thickness direction measured using a predetermined measurement method is 20 m or less. Therefore, the ceramic speaker can exhibit an excellent sound pressure property by frequency while being lightweight and thin, can be sintered simultaneously with an inner electrode during manufacturing, has excellent flatness by having no curve or thickness imbalance, has an excellent piezoelectric property so as to have excellent performance when applied to a speaker, and has high permittivity.

### CROSS-REFERENCE TO RELATED APPLICATIONS

This application is a National Phase Entry of International Application No. PCT/KR2024/004733, filed on Apr. 9, 2024, which is based upon and claims priority to Korean Patent Application No. 10-2023-0048101, filed on Apr. 12, 2023, the entire contents of which are incorporated herein by reference.

### TECHNICAL FIELD

The present invention relates to a ceramic speaker, and more particularly, to a ceramic speaker and a method for manufacturing the same.

### BACKGROUND

In general, a piezoelectric element refers to a device having the characteristic of converting electrical energy and mechanical energy into each other. A piezoelectric speaker is a representative acoustic component that acoustically converts the mechanical motion of such a piezoelectric element into sound through a vibration plate, thereby generating sound in a desired audible frequency range.

A general piezoelectric speaker includes a piezoelectric element and a vibration plate, which is formed larger than the piezoelectric element and bonded to one surface of the piezoelectric element to amplify vibrations generated from the piezoelectric element. The acoustic characteristics of such a piezoelectric speaker are determined by the sound pressure at each frequency, and the sound pressure at each frequency may vary depending on the material and physical properties of the vibration plate.

Vibration plates applied to piezoelectric speakers are made of materials such as metal, polymer, or pulp.

In the case of a metal-based vibration plate, the metal has excellent elasticity and a high propagation speed, providing an advantage of converting the vibration of the piezoelectric element into sound waves with high output. However, vibration in the low-frequency range may not be sufficiently transmitted, resulting in sound pressure reduction in the low range, and only the middle- and high-frequency ranges are effectively reproduced. In addition, the metal vibration plate has disadvantages of increased thickness and heavy weight.

In the case of conventional coil motor-type speakers, the first resonance frequency (fₒ) is high, and the output sound pressure is also high. However, such speakers have difficulties in being made compact and lightweight compared with piezoelectric speakers, consume a large amount of power due to the current-driven mechanism, and generate heat during long-term use. In particular, they are disadvantageous in price competitiveness due to the rising cost of rare-earth raw materials.

In contrast, a piezoelectric speaker can be easily implemented as an ultrathin structure of 3 mm or less, consumes less power due to its voltage-driven operation, and is advantageous in weight reduction compared with conventional coil-type speakers. However, it has relatively low output sound pressure and poor low-frequency sound characteristics compared with coil-type speakers. However, in the case of a piezoelectric speaker, since the first resonance frequency (fₒ) is relatively higher than that of a general speaker, the sound pressure characteristics in the low-frequency range are weak, resulting in coarse and unpleasant sound.

Accordingly, there is an urgent need for the development of a piezoelectric speaker capable of exhibiting high sound pressure characteristics.

### SUMMARY OF THE INVENTION

The present invention has been devised to solve the above-described conventional problems, and an object of the present invention is to provide a ceramic speaker that can be made lightweight and thin, can exhibit excellent sound pressure characteristics at each frequency, and can be co-sintered with an internal electrode during manufacturing.

Another object of the present invention is to provide a ceramic speaker that has excellent flatness by preventing curvature or thickness imbalance, has excellent piezoelectric properties, thereby exhibiting superior performance when applied to a speaker, and has high permittivity.

To solve the above-described problems, the present invention provides a ceramic speaker having a height deviation in the thickness direction of 20 μm or less as measured by Measurement Method 1 below:

### [Measurement Method 1]

The height of the ceramic speaker is measured along the length direction from the top of the ceramic speaker, and the height deviation is determined by calculating the difference between the maximum height value and the minimum height value.

According to one embodiment of the present invention, the ceramic speaker may have an average thickness of 80 to 1,600 μm.

In addition, the ceramic speaker may include a ceramic sheet having two or more sheet layers.

In addition, the ceramic sheet may include three sheet layers.

In addition, the ceramic speaker may include a sheet formed from a composition for a ceramic speaker including ceramics, a sintering aid, and an oxide-based additive comprising Bi₂O₃.

In addition, the ceramics may include a composition represented by the following Chemical Formula 1:

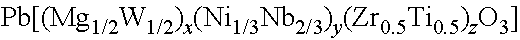

where x, y, and z are each independently a rational number from 0.01 to 0.99, and x+y+z=1.

In addition, the oxide-based additive may be included in an amount of 0.3 to 1.3 parts by weight based on 100 parts by weight of the ceramics.

In addition, the ceramic speaker may have an average sound pressure level of 70 dB SPL or more in the range of 150 to 10,000 Hz.

In addition, the present invention provides a method for manufacturing a ceramic speaker, including (1) burning out a binder of a composition for a ceramic speaker; (2) decomposing a residual binder of the binder-burned composition for a ceramic speaker; and (3) sintering the composition for a ceramic speaker from which the residual binder has been decomposed, wherein the steps (1), (2), and (3) are performed under predetermined pressing conditions.

According to one embodiment of the present invention, the method may further include, before the step (1), manufacturing a composition for a ceramic speaker in sheet form and laminating the sheets, and the pressing conditions may be defined as applying a weight of 0.11 to 0.54 g per 1 μm of total thickness of the laminated composition for a ceramic speaker prepared in sheet form.

In addition, the step (1) may be performed at a temperature of 240 to 300° C., the step (2) may be performed at a temperature of 650 to 750° C., and the step (3) may be performed at a temperature of 880 to 960° C.

In addition, the step (3) may be performed for 1 to 3 hours.

The ceramic speaker of the present invention can exhibit an excellent sound pressure characteristics by frequency while being lightweight and thin, can be sintered simultaneously with an internal electrode during manufacturing, has excellent flatness by having no curve or thickness imbalance, has an excellent piezoelectric property so as to have excellent performance when applied to a speaker, and has high permittivity.

### DETAILED DESCRIPTION

Hereinafter, exemplary embodiments of the present invention will be described in detail so that those of ordinary skill in the art can readily implement the present invention. The present invention may be embodied in many different forms and is not limited to the embodiments set forth herein.

The ceramic speaker according to the present invention is implemented such that height deviation in the thickness direction, measured by Measurement Method 1 below, is 20 μm or less.

### [Measurement Method 1]

The height of the ceramic speaker is measured along the length direction from the top of the ceramic speaker, and the height deviation is determined by calculating the difference between the maximum height value and the minimum height value.

If the height deviation in the thickness direction exceeds 20 μm, the flatness may deteriorate, resulting in degradation of sound pressure characteristics and a risk of breakage.

In addition, the ceramic speaker may have an average thickness of 80 to 1,600 μm, and preferably 100 to 1,500 μm. By satisfying the above range of average thickness, the ceramic speaker can be made lightweight and thin, can exhibit excellent sound pressure characteristics at each frequency, has excellent flatness without curvature or thickness imbalance, and is advantageous in that it provides excellent piezoelectric properties for superior performance when applied to a speaker and exhibits high permittivity.

In addition, the ceramic speaker may include a ceramic sheet having two or more sheet layers, preferably an odd number of sheet layers, more preferably three or five sheet layers, and most preferably three sheet layers, which is advantageous for achieving the object of the present invention.

Meanwhile, each of the sheets may independently have an average thickness of 20 to 70 μm, preferably 30 to 60 μm, more preferably 35 to 55 μm, and most preferably 40 to 50 μm. If the average thickness of each sheet is less than 20 μm, reliability may be degraded, and if it exceeds 70 μm, the performance of the speaker may deteriorate.

In this case, the respective sheets may have the same or different average thicknesses, and the present invention is not particularly limited thereto.

Meanwhile, each of the sheets may be formed from a composition for a ceramic speaker including ceramics, a sintering aid, and an oxide-based additive comprising Bi₂O₃.

The ceramics may include one selected from among known lead-based piezoelectric ceramic components and lead-free piezoelectric ceramic components, a mixture thereof, or an alloy thereof. Preferably, the ceramics may include at least one selected from the group consisting of lead zirconate titanate (PZT), lead magnesium niobate (PMN), lead nickel niobate (PNN), lead titanate (PT), lead magnesium tungstate (PMW), PNN-PZT, PMN-PT, PMW-PZT, BS-PT, and lanthanum-doped lead zirconate titanate (PLZT). More preferably, the ceramics may include at least one mixture or alloy selected from the group consisting of Pb(Ti, Zr)O₃, Pb(Mg_{1/3}Nb_{2/3})O₃, Pb(Mg_{1/3}Ta_{2/3})O₃, Pb(Ni_{1/3}Nb_{2/3})O₃, Pb(Mn_{1/3}Ta_{2/3})O₃, Pb(Mn_{1/3}Sb_{2/3})O₃, Pb(Zn_{1/3}Nb_{2/3})O₃, Pb(Zn_{1/3}Ta_{2/3})O₃, Pb(Mn_{1/3}Nb_{2/3})O₃, Pb(Co_{1/3}Sb_{2/3})O₃, Pb(Zn_{1/3}Nb_{2/3})O₃, Pb(Co_{1/3}Nb_{2/3})O₃, Pb(Fe_{1/3}Sb_{2/3})O₃, Pb(Fe_{1/3}Nb_{2/3})O₃, Pb(Mn_{1/3}Bi_{2/3})O₃, Pb(Mg_{1/3}Nb_{2/3})O₃, Pb(Mg_{1/3}Ta_{2/3})O₃, Pb(Ni_{1/3}Nb_{2/3})O₃, Pb(Mn_{1/3}Ta_{2/3})O₃, Pb(Mn_{1/3}Sb_{2/3})O₃, Pb(Zn_{1/3}Nb_{2/3})O₃, Pb(Zn_{1/3}Ta_{2/3})O₃, Pb(Mn_{1/3}Nb_{2/3})O₃, Pb(Co_{1/3}Sb_{2/3})O₃, Pb(Zn_{1/3}Nb_{2/3})O₃, Pb(Co_{1/3}Nb_{2/3})O₃, Pb(Fe_{1/3}Sb_{2/3})O₃, Pb(Fe_{1/3}Nb_{2/3})O₃, Pb(Mn_{1/3}Bi_{2/3})O₃, Pb(Cd_{1/2}W_{1/2})O₃, Pb(Mg_{1/2}W_{1/2})O₃, Pb(Co_{1/2}Wu_{1/2})O₃, Pb(Ni_{1/2}W_{1/2})O₃, Pb(Mn_{1/2}W_{1/2})O₃, Pb(Ca_{1/2}W_{1/2})O₃, Pb(Fe_{2/3}W_{1/3})O₃, Pb(Mn_{2/3}W_{1/3})O₃, La(Mg_{1/2}Ti_{1/2})O₃, Nd(Mg_{1/2}Ti_{1/2})O₃, Pb(Li_{1/4}Nb_{3/4})O₃, Pb(Cu_{1/4}Nb_{3/4})O₃, Pb(Li_{1/4}Sb_{3/4})O₃, and Pb(Mg_{1/2}W_{1/2})O₃—Pb(Ni_{1/3}Nb_{2/3})O₃—(Zr_{0.5}Ti_{0.5})O₃. Still more preferably, the ceramics may have a composition represented by Pb[(Mg_{1/2}W_{1/2})ₓ(Ni_{1/3}Nb_{2/3})_{y}(Zr_{0.5}Ti_{0.5})_{z}O₃], where x, y, and z are each independently a rational number of 0.01 to 0.99, and x+y+z=1, and most preferably, the ceramics may have a composition represented by Pb[(Mg_{1/2}W_{1/2})_{0.03}(Ni_{1/3}Nb_{2/3})_{0.09}(Zr_{0.5}Ti_{0.5})_{0.88}O₃], which is most advantageous for achieving the object of the present invention.

In addition, the sintering aid serves to assist the sintering of the ceramics, and any sintering aid that can be conventionally used in the art may be employed without limitation. Preferably, the sintering aid may include at least one selected from the group consisting of Li₂CO₃, CaCO₃, PbO, and CuO, and more preferably, may include one or more of Li₂CO₃ and CaCO₃, which is more advantageous for achieving the object of the present invention.

In this case, the sintering aid may be included in an amount of 0.2 to 1.5 parts by weight based on 100 parts by weight of the ceramics, and preferably in an amount of 0.3 to 1.0 parts by weight. If the amount of the sintering aid is less than 0.2 parts by weight or exceeds 1.5 parts by weight based on 100 parts by weight of the ceramics, the piezoelectric property may be deteriorated.

In addition, the oxide-based additive can lower the sintering temperature of the ceramics, thereby enabling co-sintering with an internal electrode, and serves to provide excellent piezoelectric properties so that superior performance can be achieved when applied to a speaker.

The oxide-based additive may include Bi₂O₃ as described above and may further include Sb₂O₅. However, it is preferable that the oxide-based additive includes only Bi₂O₃, which can lower the sintering temperature of the ceramics, thereby enabling co-sintering with an internal electrode, and is more advantageous in that excellent piezoelectric properties can be achieved, resulting in superior performance when applied to a speaker. Meanwhile, when Sb₂O₅ is further included, the sinterability may be relatively degraded compared to when it is not included, thereby lowering the piezoelectric property and permittivity. Therefore, the oxide-based additive may not include Sb₂O₅.

In this case, the oxide-based additive may be included in an amount of 0.3 to 1.3 parts by weight based on 100 parts by weight of the ceramics, and preferably in an amount of 0.5 to 1 parts by weight. If the oxide-based additive is less than 0.3 parts by weight based on 100 parts by weight of the ceramics, the sinterability may be poor, and the piezoelectric property and permittivity may be low. On the other hand, if the oxide-based additive exceeds 1.3 parts by weight based on 100 parts by weight of the ceramics, the piezoelectric property may be reduced.

Meanwhile, the composition for a ceramic speaker may further include a solvent.

The solvent may be a known solvent that facilitates the dispersion of the above-described ceramics, sintering aid, and oxide-based additive, and does not interfere with the dissolution of a binder. For example, the solvent may be a mixed solvent including one or more organic solvents such as toluene and ethanol.

In addition, the composition for a ceramic speaker may further include, in addition to the components described above, known binders, plasticizers, dispersants, or defoaming agents, and the present invention is not particularly limited thereto.

Non-limiting examples of the plasticizer may include phthalate esters such as dioctyl-4,5-epoxy-hexahydrophthalate, tris-(octoxycarbonylethyl)isocyanurate, tristearin, epoxidized soybean oil, and other similar compounds, or mixtures thereof.

In addition, the ceramic speaker according to the present invention may have an average sound pressure level of 70 dB SPL or more in the range of 150 to 10,000 Hz, and preferably 73 dB SPL or more in the range of 150 to 10,000 Hz.

Since the ceramic speaker according to the present invention satisfies the above sound pressure level range at a frequency of 150 to 10,000 Hz, it can be made lightweight and thin while exhibiting excellent sound pressure characteristics at different frequencies.

In addition, the ceramic speaker according to the present invention is manufactured through a method including (1) a step of burning out a binder of a composition for a ceramic speaker, (2) a step of decomposing a residual binder of the binder-burned composition for a ceramic speaker, and (3) a step of sintering the composition for a ceramic speaker from which the residual binder has been decomposed, wherein the steps (1), (2), and (3) are performed under predetermined pressing conditions.

The step of burning out the binder may be performed under conditions commonly used in the art, and preferably at a temperature of 240 to 300° C., more preferably at a temperature of 260 to 280° C., which is more advantageous for achieving the object of the present invention.

In addition, the step of decomposing the residual binder may be performed under conditions commonly used in the art, and preferably at a temperature of 650 to 750° C., more preferably at a temperature of 680 to 720° C., which is more advantageous for achieving the object of the present invention.

Meanwhile, the sintering step may be performed such that the composition for a ceramic speaker and an internal electrode are co-sintered, whereby the process can be simplified while simultaneously exhibiting excellent piezoelectric property and permittivity.

The sintering step may be performed at a temperature of 880 to 960° C., preferably at a temperature of 900 to 940° C., and more preferably at a temperature of 910 to 930° C. If the sintering temperature is lower than 880° C., sintering may not proceed to a desired level, resulting in low piezoelectric property and permittivity. If the sintering temperature exceeds 960° C., the connectivity of the internal electrode may deteriorate during co-sintering with the internal electrode, thereby lowering the permittivity and sound pressure characteristics.

In addition, the sintering step may be performed for 1 to 3 hours, preferably for 1.5 to 2.5 hours. If the sintering step is performed for less than 1 hour, sintering may not proceed to a desired level, resulting in low piezoelectric property and permittivity. If the sintering step is performed for more than 3 hours, reliability degradation and an increase in permittivity may occur.

Meanwhile, the method for manufacturing a ceramic speaker according to the present invention may further include, before the binder removal step, a step of forming the above-described composition for a ceramic speaker into a sheet, and a step of laminating the composition for a ceramic speaker formed into a sheet.

In this case, the step of forming into a sheet may be performed without limitation by any sheet-forming method conventionally used in the art, and preferably by a casting or pressing method, but is not limited thereto.

In addition, the laminating step may be performed by any method conventionally used in the art, and therefore, the present invention is not particularly limited thereto.

Meanwhile, as described above, the method for manufacturing the ceramic speaker is performed under predetermined pressing conditions. In this case, the pressing conditions may be defined as applying a weight of 0.11 to 0.54 g per 1 μm of total thickness of the laminated composition for a ceramic speaker prepared in sheet form, and preferably applying a weight of 0.12 to 0.534 g per 1 μm of thickness. If the applied weight per 1 μm of total thickness of the laminated composition for a ceramic speaker prepared in sheet form is less than 0.11 g, the flatness may deteriorate, whereas if it exceeds 0.54 g, the possibility of breakage during sintering may increase.

The present invention will be described in more detail through the following examples, but the following examples are not intended to limit the scope of the present invention, which should be construed to aid understanding of the present invention.

### EXAMPLES

### Example 1

First, a composition for a ceramic speaker was prepared by including 0.6 parts by weight of an oxide-based additive of Bi₂O₃, 0.7 parts by weight of a sintering aid containing Li₂CO₃ and CaCO₃ in a weight ratio of 1:1, and 6.5 parts by weight of a binder, based on 100 parts by weight of ceramics having an average particle size of 0.75 μm and a composition represented by Pb[(Mg_{1/2}W_{1/2})_{0.03}(Ni_{1/3}Nb_{2/3})_{0.09}(Zr_{0.5}Ti_{0.5})_{0.88}O₃].

The prepared composition for a ceramic speaker was molded into sheets by a tape casting method, and three sheet-shaped compositions for a ceramic speaker were laminated to form a laminate. A metal for forming a metal layer, namely silver (Ag), was disposed on the uppermost surface and the lowermost surface of the laminate and on the interfaces between the respective sheet-shaped compositions for a ceramic speaker. The laminate was then subjected to a pressing condition in which a weight of 40 g was applied in a furnace, heated at a heating rate of 0.2° C./min, and heat-treated at 270° C. for 3 hours to burn out the binder. Thereafter, it was heated at a heating rate of 3° C./min and heat-treated at 700° C. for 2 hours to decompose the residual binder, followed by heating at a heating rate of 3° C./min and maintaining the temperature at 920° C. for 2 hours to perform sintering. Afterward, the laminate was cooled under natural cooling conditions to produce a ceramic speaker module including a ceramic sheet having three sheet layers and an electrode layer including metal layers disposed on the uppermost and lowermost surfaces of the ceramic sheet and at the interfaces between the three sheet layers. In this case, each of the three layers of sheets had an average thickness of 43 μm, the metal layers on the uppermost and lowermost surfaces of the ceramic sheet had a thickness of 10 μm, and the metal layers disposed at the interfaces between the three layers of sheets had a thickness of 5 μm.

### Comparative Example 1

A ceramic speaker module was manufactured in the same manner as in Example 1, except that the pressing condition was omitted throughout the entire process.

### Experimental Example 1

For each of the sintered ceramics manufactured according to Example 1 and Comparative Example 1, the following physical properties were evaluated, and the results are shown in Table 1.

### 1. Measurement of Average Sound Pressure Level by Frequency

For each of the ceramic speaker modules manufactured according to the Examples and Comparative Example, each ceramic speaker module was molded to a size of 120 mm in width and 60 mm in length, placed on a SUS plate having a width of 30 cm and a length of 30 cm, and a voltage of 7 V was applied to a microphone positioned at a distance of 0.5 m to measure the average sound pressure level at the respective frequencies shown below. The initial average sound pressure level by frequency, the average sound pressure level by frequency after 168 hours under conditions of 85° C. and 85% relative humidity, and the average sound pressure level by frequency after 336 hours were measured, and the results are shown in Table 1.
1) Frequency range: 150-2,000 Hz
2) Frequency range: 150-1,000 Hz
3) Frequency range: 300-800 Hz
4) Frequency range: 1,000-10,000 Hz
5) Frequency range: 2,000-4,000 Hz
6) Frequency range: 150-8,000 Hz

### 2. Measurement of Flatness

For each of the ceramic speaker modules manufactured according to the Examples and Comparative Example, after confirming the floor zero point, the height deviation was measured by using a flatness measuring device (AOD5-N1, Sick Co.) to measure the height of the ceramic speaker while moving along the length direction from the top of the ceramic speaker, and the height deviation was determined by calculating the difference between the maximum and minimum height values.

TABLE 1

| | | | | | | Comparative | | |
|---|---|---|---|---|---|---|---|---|
| | | | Example 1 | | | Example 1 | | |
| | | | | After | After | | After | After |
| | | | Ini- | 168 | 336 | Ini- | 168 | 336 |
| Classification | | | tial | hours | hours | tial | hours | hours |
| Average | 150-2,000 | Hz | 78.81 | 79.73 | 79.95 | 76.45 | 75.45 | 76.24 |
| sound | 150-1,000 | Hz | 80.78 | 81.94 | 82.64 | 78.27 | 76.64 | 77.73 |
| pressure | 300-800 | Hz | 83.28 | 84.32 | 84.81 | 79.76 | 78.29 | 79.38 |
| level by | 1,000-10,000 | Hz | 77.73 | 78.29 | 78.63 | 75.25 | 74.23 | 74.86 |
| frequency | 2,000-4,000 | Hz | 76.37 | 77.36 | 79.06 | 76.02 | 73.96 | 74.97 |
| (dB SPL) | 150-8,000 | Hz | 79.18 | 80.02 | 80.51 | 77.28 | 76.11 | 76.95 |

| | | |
|---|---|---|
| Flatness measurement (μm) | 14 | 29 |

### Examples 2 to 4

Ceramic speaker modules as shown in Table 2 were manufactured in the same manner as in Example 1, except that the number and thickness of the laminated sheets and the number of metal layers disposed at the interfaces between the sheets were changed.

### Experimental Example 2: Measurement of Average Sound Pressure Level by Frequency

For each of the ceramic speaker modules manufactured according to Examples 1 to 4, each ceramic speaker module was molded to a size of 120 mm in width and 60 mm in length, placed on a SUS plate having a width of 30 cm and a length of 30 cm, and a voltage of 7 V was applied to a microphone positioned at a distance of 0.5 m to measure the average sound pressure level at the respective frequencies shown below. The results are shown in Table 2.
Frequency range: 150-2,000 Hz
Frequency range: 150-1,000 Hz
Frequency range: 300-800 Hz
Frequency range: 1,000-10,000 Hz
Frequency range: 2,000-4,000 Hz
Frequency range: 150-8,000 Hz

TABLE 2

| | | Example | Example | Example | Example |
|---|---|---|---|---|---|
| Classification | | 1 | 2 | 3 | 4 |
| Ceramic | Number of sheet | 3 layer | 2 layer | 4 layer | 1 layer |
| sheet | layers | | | | |
| Metal layer | Thickness of metal | 10 | 10 | 10 | 10 |
| | layer (μm) | | | | |
| 1st-layer | Sheet thickness | 43 | 67 | 45 | 150 |
| sheet | (μm) | | | | |
| Metal layer | Thickness of metal | 5 | 5 | 5 | 10 |
| | layer (μm) | | | | |
| 2nd-layer | Sheet thickness | 43 | 67 | 45 | — |
| sheet | (μm) | | | | |
| Metal layer | Thickness of metal | 5 | 10 | 5 | — |
| | layer (μm) | | | | |
| 3rd-layer | Sheet thickness | 43 | — | 45 | — |
| sheet | (μm) | | | | |
| Metal layer | Thickness of metal | 10 | — | 5 | — |
| | layer (μm) | | | | |
| 4th-layer | Sheet thickness | — | — | 45 | — |
| sheet | (μm) | | | | |
| Metal layer | Thickness of metal | — | — | 10 | — |
| | layer (μm) | | | | |
| Total thickness of ceramic sheet | | 159 | 159 | 215 | 170 |
| and electrode layer (μm) | | | | | |
| Average | 150-2,000 Hz | 78.81 | 69.98 | 79.58 | 69.07 |
| sound | 150-1,000 Hz | 80.78 | 71.25 | 81.39 | 69.27 |
| pressure level | 300-800 Hz | 83.28 | 73.68 | 83.83 | 71.65 |
| by frequency | 1,000-10,000 Hz | 77.73 | 67.89 | 78.30 | 68.07 |
| (dB SPL) | 2,000-4,000 Hz | 76.37 | 66.53 | 78.18 | 68.08 |
| | 150-8,000 Hz | 79.18 | 69.39 | 79.67 | 68.49 |

As shown in Table 2, Examples 1 to 3, which satisfy all the conditions including the number of laminated sheets according to the present invention, exhibit significantly superior average sound pressure levels by frequency compared with Example 4, which does not satisfy such conditions. Specifically, Example 1, in which three sheets were laminated, showed a remarkably higher average sound pressure level by frequency than Example 2, in which two sheets were laminated.

In addition, Example 1, in which three sheets were laminated, exhibited sound pressure characteristics equivalent to those of Example 3, in which four sheets were laminated, while having a thinner thickness.

Furthermore, Example 1, in which three sheets were laminated, showed a remarkably higher average sound pressure level by frequency than Example 4, in which a single sheet was laminated.

### Examples 5 to 12

Ceramic speaker modules as shown in Tables 3 and 4 were manufactured in the same manner as in Example 1, except that the material type and content of the oxide-based additive were changed.

### Experimental Example 3

For each of the ceramic speaker modules manufactured according to Example 1 and Examples 5 to 12, the following physical properties were evaluated, and the results are shown in Tables 3 and 4.

### 1. Measurement of Permittivity

For each of the sintered ceramics manufactured according to Example 1 and Examples 5 to 12, the capacitance of the product was measured using a capacitance meter, and the permittivity was calculated based on the measured values.

### 2. Measurement of Piezoelectric Constant d₃₃

For each of the sintered ceramics manufactured according to Example 1 and Examples 5 to 12, the piezoelectric constant d₃₃ was measured using a d₃₃ meter.

TABLE 3

| | | Exam- | Exam- | Exam- | Exam- | Exam- |
|---|---|---|---|---|---|---|
| Classification | | ple 1 | ple 5 | ple 6 | ple 7 | ple 8 |
| Oxide- | Material type | Bi₂O₃ | Bi₂O₃ | Bi₂O₃ | Bi₂O₃ | Bi₂O₃ |
| based | Content (parts | 0.6 | 0.5 | 0.8 | 1 | 1.5 |
| additive | by weight) | | | | | |

| | | | | | |
|---|---|---|---|---|---|
| Permittivity (F/m) | 2523 | 2472 | 2604 | 2640 | 2292 |
| Piezoelectric constant | 649 | 655 | 647 | 620 | 588 |
| d₃₃ (pC/N) | | | | | |

TABLE 4

| | | Example | Example | Example | Example |
|---|---|---|---|---|---|
| Classification | | 9 | 10 | 11 | 12 |
| Oxide-based | Material type | Bi₂O₃/ | Bi₂O₃/ | Bi₂O₃ | Sb₂O₅ |
| additive | | Sb₂O₅ | Sb₂O₅ | | |
| | Content (parts | 0.6/ | 0.6/ | 0 | 0.6 |
| | by weight) | 0.2 | 0.3 | | |

| | | | | |
|---|---|---|---|---|
| Permittivity (F/m) | 2030 | 1248 | 995 | 462 |
| Piezoelectric constant d33 (pC/N) | 595 | 417 | 282 | 79 |

As shown in Tables 3 and 4, Example 1 and Examples 5 to 7, which satisfy all the conditions regarding the material type and content of the oxide-based additive according to the present invention, were found to simultaneously exhibit significantly superior permittivity and piezoelectric properties (piezoelectric constant d₃₃) compared with Examples 8 to 12, which fail to satisfy at least one of these conditions. Specifically, it can be confirmed that Example 1 and Examples 5 to 7, which satisfy the content range of Bi₂O₃ according to the present invention, exhibit significantly superior permittivity and piezoelectric properties compared with Example 8, in which the content of Bi₂O₃ exceeds the defined range.

In addition, it can be confirmed that Example 1, in which the oxide-based additive according to the present invention does not include Sb₂O₅, exhibits significantly superior permittivity and piezoelectric properties compared with Examples 9 and 10, in which the oxide-based additive includes Sb₂O₅. In particular, it was observed that as the content of Sb₂O₅ increases, the permittivity and piezoelectric properties gradually decrease.

It can also be confirmed that Example 1 and Examples 5 to 7, which satisfy the content range of Bi₂O₃ according to the present invention, exhibit significantly superior permittivity and piezoelectric properties compared with Example 11, in which the content of Bi₂O₃ is below the defined range.

Furthermore, it can be confirmed that Example 1, in which the oxide-based additive according to the present invention includes Bi₂O₃, exhibits significantly superior permittivity and piezoelectric properties compared with Example 12, in which the oxide-based additive does not include Bi₂O₃.

Although exemplary embodiments of the present invention have been described above, the scope of the present invention is not limited to the embodiments set forth herein. Those skilled in the art who understand the spirit of the present invention may readily propose other embodiments by adding, modifying, deleting, or supplementing components within the scope of the present invention, and such embodiments should also be regarded as falling within the scope of the present invention.

1. A ceramic speaker having a height deviation in the thickness direction of 20 μm or less as measured by Measurement Method 1 below:
[Measurement Method 1]
the height of the ceramic speaker is measured along the length direction from the top of the ceramic speaker, and the height deviation is determined by calculating the difference between the maximum height value and the minimum height value.

2. The ceramic speaker of claim 1, wherein the ceramic speaker has an average thickness of 80 to 1,600 μm.

3. The ceramic speaker of claim 1, wherein the ceramic speaker comprises a ceramic sheet having two or more sheet layers.

4. The ceramic speaker of claim 3, wherein the ceramic sheet comprises three sheet layers.

5. The ceramic speaker of claim 1, wherein the ceramic speaker comprises a sheet formed from a composition for a ceramic speaker comprising:
ceramics;
a sintering aid; and
an oxide-based additive comprising Bi₂O₃.

6. The ceramic speaker of claim 5, wherein the ceramics comprise a composition represented by the following Chemical Formula 1: 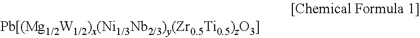
where x, y, and z are each independently a rational number from 0.01 to 0.99, and x+y+z=1.

7. The ceramic speaker of claim 5, wherein the oxide-based additive is included in an amount of 0.3 to 1.3 parts by weight based on 100 parts by weight of the ceramics.

8. The ceramic speaker of claim 1, wherein the ceramic speaker has an average sound pressure level of 70 dB SPL or more in the range of 150 to 10,000 Hz.

9. A method for manufacturing a ceramic speaker, comprising:
(1) burning out a binder of a composition for a ceramic speaker;
(2) decomposing a residual binder of the binder-burned composition for a ceramic speaker; and
(3) sintering the composition for a ceramic speaker from which the residual binder has been decomposed,
wherein the steps (1), (2), and (3) are performed under predetermined pressing conditions.

10. The method for manufacturing a ceramic speaker according to claim 9, further comprising, before the step (1), manufacturing a composition for a ceramic speaker in sheet form and laminating the sheets,
wherein the pressing conditions are defined as applying a weight of 0.11 to 0.54 g per 1 μm of total thickness of the laminated composition for a ceramic speaker prepared in sheet form.

11. The method for manufacturing a ceramic speaker according to claim 9,
wherein the step (1) is performed at a temperature of 240 to 300° C.,
the step (2) is performed at a temperature of 650 to 750° C., and
the step (3) is performed at a temperature of 880 to 960° C.

12. The method for manufacturing a ceramic speaker according to claim 9, wherein the step (3) is performed for 1 to 3 hours.
